(19) United States
(12) Patent Application Publication
(10) Pub. No.: US 2004/0016503 A1
(43) Pub. Date: Jan. 29, 2004

(54) Apparatus and method for producing a coated wire or other elongated article

(76) Inventor: Matthew Shawn Stowe, Osceola, AR (US)

Correspondence Address: ANTHONY NIEWYK, BAKER & DANIELS, 111 EAST WAYNE STREET, SUITE 800, FORT WAYNE, IN, 46802, US

(21) Appl. No.: 10/201,347

(22) Filed: Jul. 23, 2002

(51) Int. Cl. B29C 47/02; B32B 31/30

(52) U.S. Cl. 156/244.12; 156/244.14; 156/244.21; 156/244.23; 57/295; 156/359; 156/361; 156/498; 156/499; 156/500

(57) ABSTRACT

An apparatus and method for producing a coated wire or other elongated article including a means to extrude a polymer in tubular form around the wire or article and a means to increase the temperature of the wire or article before extrusion of the polymer thereon. The extruded polymer is elongated from the extrusion opening to the elongated article, forming a melt cone, were the relative feeding speed of the heated elongated article and the extrusion rate of the polymer are controlled and with the aid of at least a partial vacuum that is achieved in the extrusion tooling and inside the melt cone the extruded polymer tightly encases the wire achieving a thin polymer coating.

### BACKGROUND OF THE INVENTION

Magnet wire and other electrically conductive elongated articles have long been used in magnetic devices and for other electrical applications. Many of these devices or applications require the elongated article to be insulated from subsequent windings or other metallic components. The insulating process of the elongated articles is typically an additional process because the article forming processes, such as drawing, rolling or conforming, operate at slower speeds and because of equipment design are constrained to certain cross sections. For example, conform processes are restricted by cross sections and type of metal, thus if put in tandem with the insulating process as outlined by Foster, Boatwright and Lewis in U.S. Pat. No. 5,151,147, the insulating process is constrained by the size and type of conform machine.

### SUMMARY OF THE INVENTION

Presently, the NEMA MW 1000 Standards apply to round, rectangular, and square, plated or unplated, copper and aluminum magnet wire with film insulations or fibrous coverings, or a combination of both, for use in electrical apparatus. The Standards define film coating as a continuous barrier of polymeric insulation. Various resins or polymeric materials are listed in the Standards and the resins specified may be modified. A modified resin is defined as a resin that has undergone a chemical change, or contains one or more additives to enhance certain performance or application characteristics. It must retain the essential chemical identity of the original resin and the coated conductor must meet all specified test requirements of the appropriate MW standard.

Conventional film coated magnet wire outlined in the MW 1000-97 Standards has multiple disadvantages, including the processes employed and chemical hazards. The processes employed require multiple passes through a solvent-containing solution to achieve a minimum number of pinholes and the desired coating thickness. The solvents pose environmental hazards and with increased regulation, increase operating cost.

The present invention results in savings to the end user because of process simplification while achieving, and in some cases exceeding, the required properties of conventional insulations and the methods of applying these insulations. The polymer materials utilized are relatively solvent free, thus alleviating many of the environmental issues associated with conventional film material. In addition, the invention is unconstrained by the forming processes employed to produce the bare elongated article.

This invention entails using a bare elongated article having the desired cross section and heating the elongated article before feeding to a coating system which receives the heated elongated article and extrudes a thermoplastic polymer in tubular form around the circumference of the article. At least a partial vacuum induced through the extrusion tooling forces the polymer to contact and tightly encase the elongated article due to the pressure differential, hence forming a melt cone. The coated elongated article is cooled to allow the polymer molecules to achieve proper orientation and further cooled to room temperature prior to being coiled. The polymer extrusion temperatures, the relative feeding speed of the heated elongated article, the extrusion tooling design, the vacuum pressure and the extrusion rate of the polymer are controlled to elongate the extruded polymer with initial thickness t₁ to the required polymer coating thickness t₂ that is applied to the elongated article, where t₁>t₂.

### DRAWINGS ILLUSTRATING THE INVENTION

A present preferred embodiment of the invention is illustrated in the accompanying drawings, in which:

FIG. 1 shows schematically a side view of a production line for one embodiment of the present invention;

FIG. 2 shows a top view, partially broken away, of a horizontal section through the die crosshead and associated extrusion tooling, including the wire passing through the tooling; and

FIG. 3 shows an enlarged view, further broken away, of the section of FIG. 2, with the polymer being extruded and applied to the wire.

### DETAILED DESCRIPTION OF PREFERRED EMBODIMENTS

The present invention utilizes a heating apparatus to transfer heat to an article prior to entering the coating apparatus. The article coating apparatus is an extruder which is supplied with a semi-crystalline or amorphous polymer. The polymer exits the extruder in a tubular form having an elliptical or circular shape around the article to be coated. The polymer tube mechanically bonds with the article because of the pressure difference across the melt cone obtained by use of a vacuum unit. The desired thickness of the polymer coating is achieved by the extruder tooling design, the extruder output, the vacuum pressure and line speed.

One embodiment of the present invention is an apparatus for producing a polymer coated elongated article comprising:

a. means of receiving incoming feed of elongated article;

b. heating means for increasing the temperature of the elongated article;

c. means to extrude a thermoplastic polymer in tubular form, with either uniform or non-uniform thickness, around the circumference of the elongated article and initially spaced from the elongated article moving through the extruding means;

d. vacuum means for inducing at least a partial vacuum in a melt cone of the tubular formed polymer to force the polymer to contact and tightly encase the elongated article due to pressure differential;

e. means for subjecting the extruded polymeric coated elongated article to a cooling medium to cool the coated elongated article to a temperature suitable for the polymeric material molecules to achieve proper orientation; and

f. means for controlling the polymer extrusion temperature, the relative feeding speed of the heated elongated article, the vacuum pressure and the extrusion rate of the polymer to elongate the extruded polymer melt cone with initial thickness t₁ to the required polymer coating thickness t₂, where t₁>t₂, whereby the polymer is applied to the article producing a polymer coated elongated article

The elongated article may be a solid or hollow circular wire, a solid or hollow rectangular wire or a stranded cable. Preferably, the elongated article has a uniform cross-section. Preferably, the apparatus further includes means for cooling the cured polymer coated elongate article. Advantageously the apparatus is capable of continuous operation, i.e. continuously receiving the wire, continuously heating the wire, continuously extruding the polymer, etc.

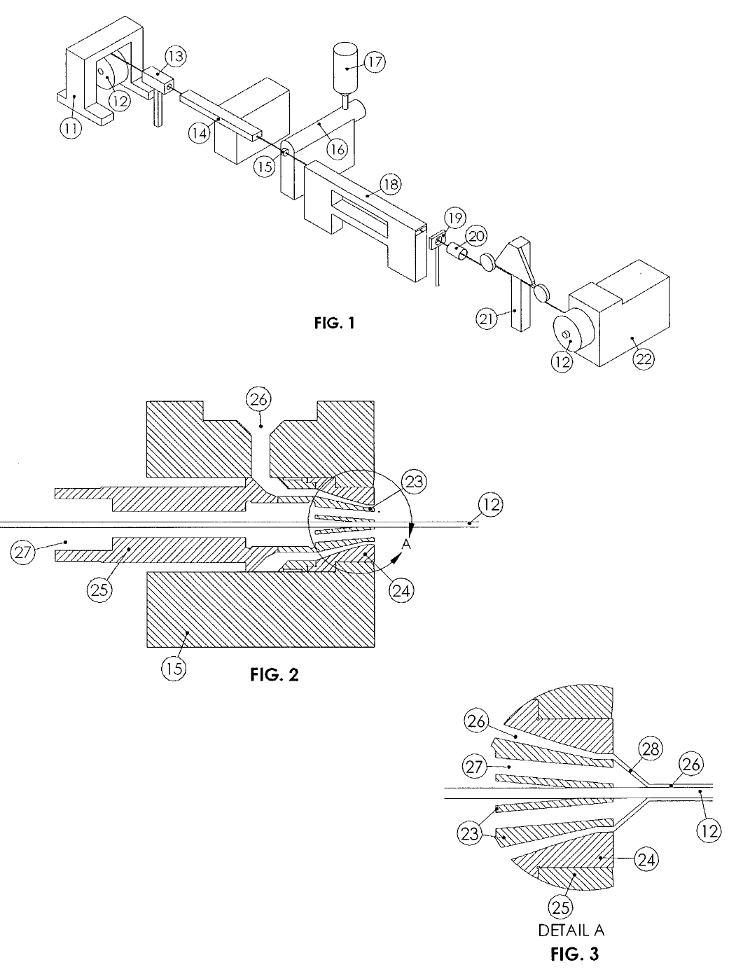

Referring now more particularly to the drawings, and initially to FIG. 1, a coil of bare metal wire 12, advantageously copper or aluminum is removed from pay-off 11. The wire 12 can have a circular or rectangular cross-sectional shape and may optionally be cleaned in cleaning station 13 to remove any debris or oil from the wire forming processes. Wire 12 then passes through heater 14 and is heated to approximately the polymer processing melt temperature. Induction and other methods of heating may be utilized and are within the scope of this invention. Advantageously the temperature of the elongated article is increased to an elevated temperature suitable for application of the polymeric material to the elongated article preliminary to applying the polymeric material to the elongated article. Preferably the elongated article is heated to a temperature less than 700° F. Most preferably, the elongated article is heated to a temperature from about 600° F. to less than about 680° F.

After being heated, the wire enters the coating process which consists of an extruder and other components. The primary components of the extruder are a motor drive, a gear train and a screw that is contained in a long barrel and keyed into the gear train. The pelletized polymer is fed into the inlet of extruder 16 from hopper 17, advantageously where the moisture level has been reduced sufficiently in preparation of extrusion. The polymer is then drawn into the extruder by the feed section of the screw. The feed section has a deep channel between the root of the screw and the barrel wall. A metering section of the screw is directly ahead of the feed section. This channel of the screw narrows dramatically and is responsible for the intense friction and melting of the thermoplastic. A pumping section is the final section of the screw, located toward the tip. In this section, the necessary pressure is developed, and the melt is homogenized and raised to the final extrusion temperature. Crosshead 15 containing the extrusion tooling is attached to the outlet of the extruder. The polymer flows through a tapered cylindrical channel of the crosshead to the extrusion tooling consisting of tip holder 25, die 24 and tip 23 where the central axis of the crosshead, extrusion tooling and wire are coincident, for extruding a thermoplastic polymer coating onto the heated wire.

As shown in FIG. 2 polymer 26 enters crosshead 15 and is forced, due to the blockage created by tip holder 25, through tip 23 and die 24. The outer surface of tip 23 and inner surface of die 24 that create the extrusion opening are designed to have a circular, elliptical or rectangular cross sectional shape with either uniform or non-uniform thickness, t₁, depending upon the cross sectional shape of the wire or desired coating. For wire with rectangular cross section, an elliptical or rectangular cross sectional extrusion opening is preferred. This prevents the accumulation of polymer on the edges of the wire, achieving a uniform coating thickness. The extrusion opening is sufficient to allow the desired coating, with thickness, t₂, on wire 12 to be achieved at the intended wire speed and extrusion rate. Advantageously the draw down ratio, consisting of the ratio of the cross sectional area of the polymer at the extrusion opening to the cross sectional area of the coating achieved on the wire, is less than 20:1. The extruded polymer, with an initial velocity VP at the extrusion opening and initially spaced around the circumference of the wire, contacts the wire as it is being pulled through the tooling at a velocity V_{w}, where V_{w}>Vₚ, forming melt cone 28 (reference FIG. 3). The cross sectional shape of the wire slot cut in tip 23 that holds wire 12 on the central axis of the extrusion tooling is made slightly larger than wire 12. Through this opening or through incorporated portholes in tip 23 a vacuum unit connected to tip holder 25 by a flexible hose draws at least a partial vacuum inside the extrusion tooling and ultimately reduces the pressure inside the melt cone forcing the polymer to tightly encase the wire because of the pressure differential across the melt cone. The pressure difference across the melt cone and the difference between V_{w} and Vₚ in conjunction with the design of the tooling and extruder output determine the polymer thickness of the insulated product, advantageously ranging from about 0.002 inches to about 0.030 inches. FIG. 3 is a further enlarged view of the indicated die area from FIG. 2 and more fully shows the details of the extrusion tooling and melt cone, with the polymer being extruded and applied to the wire.

Referring to FIG. 1, the polymer-coated wire is initially allowed to cool, advantageously in ambient air, to allow the polymer molecules to achieve proper orientation and then travels through cooling apparatus 18, that sufficiently cools, advantageously to room temperature, the coated wire through the use of cool water. The coated wire then passes through a two-axis dimensional gauge 19 and a bead chain style electrode spark tester 20 that monitor the coated wire dimensions and insulation effectiveness, respectively. Advantageously the dimensional gauge 19 may control the extruder output to accurately obtain the desired coating thickness over the continuous length of the wire. Next, the coated wire travels through capstan 21 and onto a reel turned by take-up 22, where capstan 21 provides sufficient force and controls wire tension to move the wire in a substantially straight and fixed path between pay-off 11 and take-up 22. The capstan consist of a rotating wheel with a belt kept in continuous contact with up to about one-half of the wheel diameter using a tensioning device. The wire velocity and extruder output may be synchronized though the use of computer control means. Wire of rectangular cross section may pass through the extrusion tooling with its largest cross section either horizontal or vertical, depending upon the orientation the appropriate product handling equipment will have to be employed.

The mechanical bond between the wire and polymer is achieved by the wire inlet temperature being in excess of about 600° F. and achieving an adequate pressure differential across the melt cone. In addition to the mechanical bond, by heating the wire to approximately that of the melt temperature of the polymer any thermal shock between wire and polymer is reduced, thus preventing internal stresses in the polymer.

Another embodiment of the present invention is a method for producing a polymer coated elongated article comprising:

a. feeding a supply of elongated article into a heating means;

b. heating the elongated article;

c. moving the heated elongated article through an extruder means at a first linear rate of speed;

d. extruding in the extruder means polymeric material into a tube having non-uniform thickness, with the thickness of the tube being reduced at locations corresponding to the exterior of the elongated article to offset the tendency to have excess amounts of polymeric material at the exterior of the coated elongated article, the tube being around and spaced from the elongated article, the tube being extruded at a linear rate of speed less than the first rate so that the thickness of the polymer material is reduced before it contacts the elongated article; and

e. providing at least a partial vacuum between the elongated article and the polymeric material being extruded, thereby causing atmospheric pressure to progressively press the extruded polymeric material into contact with the elongated article.

Preferably steps (a), (b), (c), (d) and (e) are performed continuously.

Advantageously the temperature of the elongated article is increased to an elevated temperature suitable for application of the polymeric material to the elongated article preliminary to applying the polymeric material to the elongated article. Preferably the elongated article is heated in step (b) to a temperature less than 700° F. Most preferably the elongated article is heated in step (b) to a temperature from about 600 degrees F. to less than about 680 degrees F. Advantageously the polymeric material is polyphenylsulfone.

As with the above described apparatus the elongated article may be a solid circular wire, a solid rectangular wire, or a stranded wire and preferably the elongated article has a uniform cross-section.

In addition to the magnet wire applications, this invention is also applicable to wire used for other purposes and encompasses other cross sections, regular and irregular. In addition, various metals may be used including aluminum alloys, such as 1XXX, 3xxx, 5XXX, 6XXX and 8XXX alloy groups, and coppers, such as C11000, C10100 and C10200.

Tests of the invention were performed using C11000 copper magnet wire with thickness and width dimensions of 0.055 inches and 0.299 inches, respectively. The wire exited the induction wire heater at a temperature greater than 600° F. and entered the crosshead. The polymer was supplied to the crosshead and thus the extrusion tooling, by a 2.5 inch Davis Standard extruder with a 24:1 L/D ratio at a temperature of 660° F. The polymer used in this test was a polyphenylsulfone, however other polymers could be used such as polyphenylene sulfide. The tip, tip holder, and die were designed for this application, achieving a draw down ratio of 16:1. The polymer was dried overnight in a desiccant dryer at 290° F. to obtain a dew point of −35° F. The extruder zone temperatures for the processing of the polymer are as shown in Table 1.

TABLE 1
Polymer Processing Temperatures

| | |
|---|---|
| Zone 1 | 630° F. |
| Zone 2 | 650° F. |
| Zone 3 | 660° F. |
| Zone 4 | 670° F. |
| Zone 5 | 680° F. |
| Zone 6 | 680° F. |
| Zone 7 | 690° F. |

The line speed of the process was 200 ft/min due to the capabilities of the induction heater. At this speed, the screw was rotating at 10 rpm. Faster line speeds are attainable utilizing a more powerful induction heater or other wire-heating device. A vacuum pressure of 5 inHg between the melt cone and wire was used and achieved the desired level of adhesion. The extruder, capstan and take-up operations were synchronized utilizing Reliance digital DC drives. The product produced possessed the characteristics shown in Table 2.

TABLE 2
Product Characteristics

| | |
|---|---|
| Insulation Thickness (x-axis) | 0.0085 inches |
| Insulation Thickness (y-axis) | 0.0045 inches |
| Dielectric Breakdown | 10.51 kV |
| 180° Flat Wise Bend Test | Pass/no signs of |
| (0.250 in. mandrel) | stress in insulation |

While the preferred apparatus and methods for practicing the invention have been illustrated and described, it will be understood that the invention may be otherwise variously embodied and practiced within the scope of the following claims.

What is claimed is:

1. An apparatus for producing a polymer coated elongated article comprising:
a. means of receiving incoming feed of elongated article;
b. heating means for increasing the temperature of the elongated article;
c. moving the heated elongated article through an extruder means at a first linear rate of speed;
d. means to extrude a thermoplastic polymer in tubular form, with either uniform or non-uniform thickness, around the circumference of the elongated article and initially spaced from the elongated article moving through the extruding means;
e. vacuum means for inducing at least a partial vacuum in a melt cone of the tubular formed polymer to force the polymer to contact and tightly encase the elongated article due to pressure differential;
f. means for subjecting the extruded polymeric coated elongated article to a cooling medium to cool the coated elongated article to a temperature suitable for the polymeric material molecules to achieve proper orientation, and
g. means for controlling the polymer extrusion temperatures, the relative feeding speed of the heated elongated article, the vacuum pressure and the extrusion rate of the polymer to elongate the extruded polymer melt cone with initial thickness t₁ to the required polymer coating thickness t₂, where t₁>t₂, whereby the polymer is applied to the article producing a polymer coated elongated article.

2. The apparatus of claim 1 wherein said extruding means includes an extrusion die orifice having outwardly bowed sides to reduce the accumulation of excess amounts of polymeric material at corners of the coated elongated article.

3. The apparatus according to claim 1, further including heating means for curing the polymer coated elongated article.

4. The apparatus according to claim 3, further including means for cooling the cured polymer coated elongated article.

5. The apparatus of claim 1 capable of operating continuously.

6. A method for producing a polymer coated elongated article comprising:
a. feeding a supply of elongated article into a heating means;
b. heating the elongated article;
c. moving the heated elongated article through an extruder means at a first linear rate of speed;
d. extruding in the extruder means polymeric material into a tube having non-uniform thickness, with the thickness of the tube being reduced at locations corresponding to the exterior of the elongated article to offset the tendency to have excess amounts of polymeric material at the exterior of the coated elongated article, the tube being around and spaced from the elongated article, the tube being extruded at a linear rate of speed less than the first rate so that the thickness of the polymer material is reduced before it contacts the elongated article; and
e. providing at least a partial vacuum between the elongated article and the polymeric material being extruded, thereby causing atmospheric pressure to progressively press the extruded polymeric material into contact with the elongated article.

7. The method according to claim 6, wherein the temperature of the elongated article is increased in step (b) to an elevated temperature suitable for application of the polymeric material to the elongated article preliminary to applying the polymeric material to the elongated article.

8. The method according to claim 7, in which the elongated article is heated in step (b) to a temperature less than 700° F.

9. The method according to claim 8 in which the elongated article is heated in step (b) to a temperature from about 600 degrees F. to less than about 680 degrees F.

10. The method according to claim 6, in which the polymeric material is polyphenylsulfone.

11. The method according to claim 6 wherein the elongated article is a solid or hollow circular wire.

12. The method according to claim 6 wherein the elongated article is a solid or hollow rectangular wire.

13. The method according to claim 6 wherein the elongated article is a stranded cable.

14. The method according to claim 6 wherein the elongated article has a uniform cross-section.

15. The method of claim 6 wherein steps (a), (b), (c), (d), and (e) are performed continuously.

16. The apparatus according to claim 1, wherein the temperature of the elongated article is increased in step (b) to an elevated temperature suitable for application of the polymeric material to the elongated article preliminary to applying the polymeric material to the elongated article.

17. The apparatus according to claim 1, in which the polymeric material is polyphenylsulfone.

18. The apparatus according to claim 1, wherein the elongated article is a solid or hollow circular wire.

19. The apparatus according to claim 1 wherein the elongated article is a solid or hollow rectangular wire.

20. The apparatus according to claim 1 wherein the elongated article is a stranded cable.

21. The apparatus according to claim 1 wherein the elongated article has a uniform cross-section.
